(19) United States
(12) Patent Application Publication
(10) Pub. No.: US 2012/0076692 A1
(43) Pub. Date: Mar. 29, 2012

(54) Modular Component Synthesis Unit

(75) Inventor: Reza Miraghaie, Culver City, CA (US)

(73) Assignee: SIEMENS MEDICAL SOLUTIONS USA, INC., Malvern, PA (US)

(21) Appl. No.: 13/242,503

(22) Filed: Sep. 23, 2011

Related U.S. Application Data
(60) Provisional application No. 61/385,647, filed on Sep. 23, 2010.

(51) Int. Cl. B01J 19/00

(52) U.S. Cl. 422/49; 422/159

(57) ABSTRACT

A kit, for synthesizing a compound or element, which includes a modular reagent source, a modular trap and release apparatus, and a modular reaction unit. The modular reagent source includes a reagent. The modular trap and release apparatus is configured to separate components of the reagent. The modular reaction unit which is in fluid communication with the modular reagent source and the modular trap and release apparatus. In addition, the modular reaction unit includes a reaction vessel configured to facilitate a chemical reaction.

The present application claims priority from Provisional U.S. Patent Application No. 61/385,647 filed on Sep. 23, 2010, the disclosure of which is incorporated herein by reference in its entirety.

### BACKGROUND OF THE INVENTION

1. Field of the Invention

The present invention relates generally to apparatuses for chemical synthesis. More particular, it relates to fluidic devices and related technologies, and to chemical processes using such devices. More specifically, the invention relates to synthesis of radioactive compounds for imaging, such as by positron emission tomography (PET), in an efficient manner. In particular, embodiments of the present invention relate to modular components of a synthesis system or kit that allows an operator to easily change and move components, which makes the system more versatile in synthesizing different compounds and elements. In other words, the system is substantially “universal” in that it can be easily used to synthesize many different chemicals and elements.

2. Description of Related Art

As new radio-labeled compounds are introduced to the market with more complex synthesis procedures, design of a synthesis unit capable of addressing all the processes can result in utilization of complex hardware, plumbing, and excessive use of components that can result in higher risk of nodal failure. Additionally, serviceability of the units can be greatly affected by such a complex setup, thereby affecting the appeal and competitiveness of the instrument with respect to other devices in the market.

### SUMMARY OF THE INVENTION

In one embodiment, the present invention is a kit for synthesizing a compound or element. The kit includes a modular reagent source comprising a reagent, and a modular trap and release apparatus. The modular trap and release apparatus includes an apparatus configured to separate components of the reagent and a modular reaction block/unit in fluid communication with the modular reagent source and the modular trap and release apparatus. The modular reaction block/unit includes a reaction vessel configured to facilitate a chemical reaction. The kit may also include a modular intermediate collection apparatus in fluid communication with the modular reaction block/unit, where the modular intermediate collection apparatus comprises an intermediate collection vial.

One advantage of this invention is that it enables rapid modification and design of production line for synthesis of various radio-labeled compounds. In some embodiments, the concept of this invention is analogous to circuit design and assembly in electronics applications.

One goal of the modular multi-line radio-synthesis unit is to modularize and simplify design and selection of components needed for reliable, repeatable, and straightforward production of radio-labeled compounds. As new radio-labeled compounds are introduced to the market with more complex synthesis procedures, design of a synthesis unit capable of addressing all the processes can result in utilization of complex hardware, plumbing, and excessive use of component that can result in higher risk of nodal failure. Additionally, serviceability of the units can be greatly affected by such a complex setup, thereby affecting the appeal and competitiveness of the instrument with respect to other devices in the market.

The invention simplifies the overall structure of the synthesis system and peripheral instrumentation, and reduces the complexity of the components. It also provides broader range of synthesis architecture. Easy, fool-proof, non-expert installation and replacement of the components are directly affected by this invention. From the operational conditions of the device, it will provide higher degrees of reliability and good manufacturing processes along with ease of use and service.

The modular nature of the present invention helps placing the components of a synthesis unit together rather easily. The concept may be likened to an electronic circuit board in some respects. This modular concept allows use of single-use, GMP (Good Manufacturing Practice) oriented parts for clinical dose productions if need be. The use of two- and three-way valves allows easier control of flow through the system. Also, using solid blocks with internal plumbing and electrical connections eliminates fittings, and too many wires and tubes going back and forth between the components. Preferably, the modular components herein are not connected via traditional tubes, which may wear out easily and/or become contaminated. In addition, any or all of the modular components below, may be disposable.

### BRIEF DESCRIPTION OF THE DRAWINGS

FIG. 1 shows a system or “kit” of one embodiment of the present invention as generic blocks representing the modular components (or sub-modules);

FIG. 2 shows the components of FIG. 1 in a perspective view, as they may appear in one particular embodiment;

FIG. 3 shows a more detailed perspective view of the modular reaction block shown in FIG. 2;

FIG. 4 shows a more detailed perspective view of the modular trap shown in FIG. 2;

FIGS. 5A and 5B show a more detailed perspective view of the modular reagent source shown in FIG. 2; and

FIG. 6 shows a more detailed perspective view of the modular intermediate collection apparatus shown in FIG. 2.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

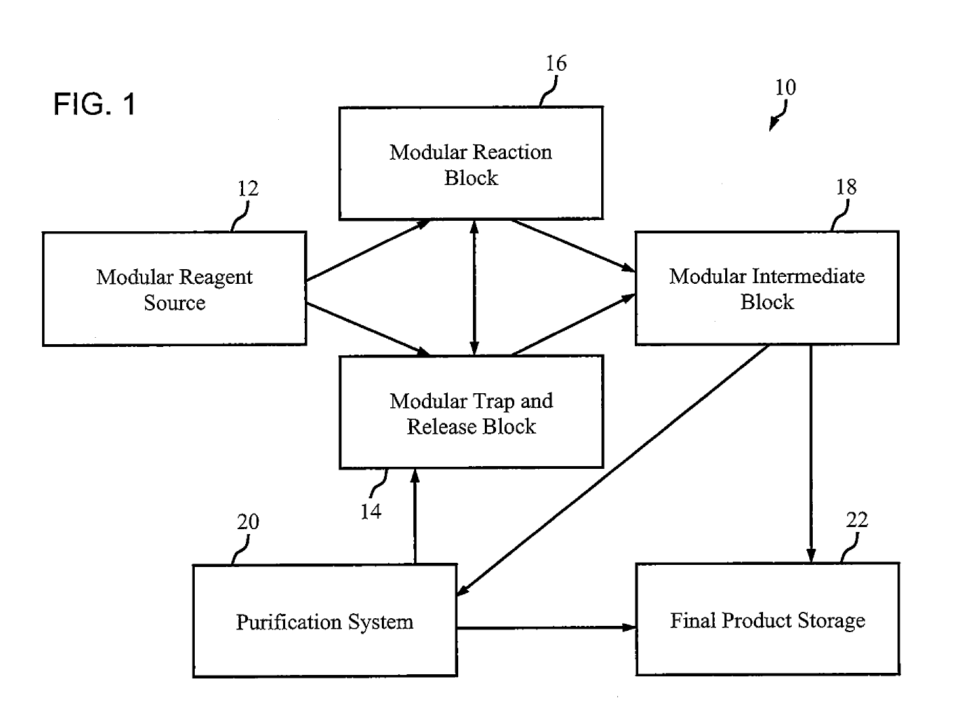

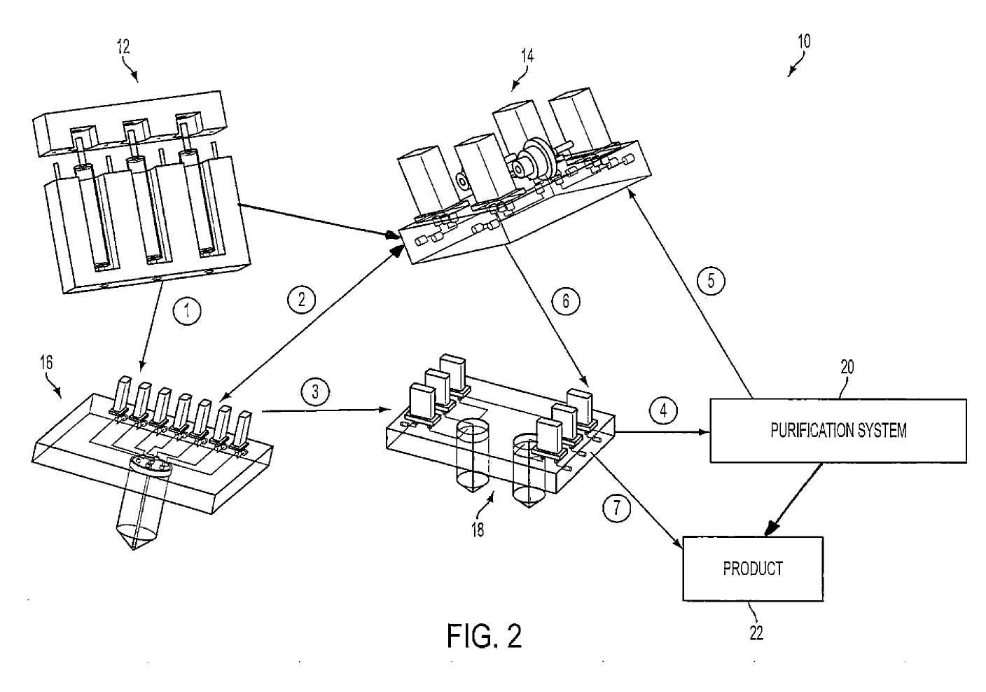

FIGS. 1 and 2 show the system or “kit” 10 of one embodiment of the present invention. FIG. 1 shows these components as generic blocks representing the modular components (or sub-modules) and FIG. 2 shows these components in a perspective view, as they may appear in one particular embodiment.

In a preferred embodiment, the system is configured to store, transport, facilitate the reaction of, etc., of volumes up to about 100 mL. However, it may facilitate smaller amounts of about 1 mL to 10 mL.

In another embodiment, each component of the system is microfluidic. The terms “microfluidic device”, “microfluidic chip”, “synthesis chip”, and “chip” refer to a unit or device that permits the manipulation and transfer of small amounts of liquid of as much as 10 milliliters (e.g., microliters (1 μL to less than 1 mL), nanoliters (1 nl to less than 1μ), etc.) into a substrate comprising micro-channels and micro-compartments. The microfluidic device may be configured to allow the manipulation of liquids, including reagents and solvents, to be transferred or conveyed within the micro-channels and reaction chamber using mechanical or non-mechanical pumps.

As shown in FIGS. 1 and 2, in one embodiment, the kit 10 comprises a modular reagent source 12, a modular trap and release apparatus 14, a modular reaction block 16, and a modular intermediate collection apparatus or block 18. Preferably, each of these modular components is capable of being in fluid communication with any or all of the other modular components. By “fluid communication”, it is meant that gas and/or liquids may pass between the components. By “modular”, it is meant that each component is capable of being quickly and easily placed in fluid communication with another component of the system or kit, and then quickly and easily “detached” from such communication.

As shown in FIGS. 1 and 2, in one embodiment, the modular reagent source 12 is in fluid communication with the modular trap and release apparatus 14, which is in fluid communication with the modular reaction block 16, which is in fluid communication with the modular intermediate collection apparatus 18. (FIG. 2 represents a simple production scheme with (circled) numbers as possible time sequence of events and arrows as direction of the flow of material from module to module. All the signals used for operating the valves can be of digital type bundled and transmitted via data acquisition boards and logic control devices.)

The modular intermediate collection apparatus 18 may be in fluid communication with a purification system 20, which may be in fluid communication with the modular trap and release apparatus 14. The modular intermediate collection apparatus 18 may also be in fluid communication with a product collection container or apparatus 22. To form a production line using the sub-modules, a series of plumbing and electrical connections may be used to form the network of fluids and signals required for sequential performance of the box. In addition, the system may be fully automated. It is noted that the system 10 may comprise other elements such as various waste collection vials, and vials for collection of raw and/or purified product.

The modular components may be in fluid communication via at least one docking station (not shown). The docking station may provide the fluid lines or channels that connect the modular components. The docking station may also comprise any electrical components necessary to operate the various valves, heating elements, etc., that may be a part of the various modular components. These electrical components may also provide for automated operation of the kit or system when interfaced with a computer.

To form a “production line” using the modular components, a series of plumbing and electrical connections may be used to form the network of fluids and signals required for sequential performance of the system. In one embodiment, each component of the system may be attachable to a fluidic “breadboard”, “circuit board”, or “docking station.” In this embodiment, the desired components are in fluid communication with a bread board that comprises a series of channels for transporting reagents (fluids, gases, etc.). For example, the modular reaction block 16 is attached to the bread board, as are the modular trap and release apparatus 14 and the modular reagent source 12. These components are in fluid communication with each other via at least one channel in the bread board. The components may be in fluid communication with the bread board via a number of means. Preferably, an outlet of the component is connected to the bread board via a washer. In addition, various valves may be used to control the flow to and throughout the breadboard. Such valves may include both 2-way and 3-way valves. Preferably, gas pushes the liquids to and from the modular components. As such, at least one component, possibly the docking station, is coupled to a gas source. It is noted that the entire system may also be connected to external systems such as purifications systems, for example, HPLC columns.

FIG. 2 represents a simple production scheme with (circled) numbers as time sequence of events and arrows as direction of the flow of material from module to module. All the signals used for operating the valves can be of digital type bundled and transmitted via data acquisition boards and logic control devices. The numbers (circled) shown represent one particular operation of the system; other sequences and schemes are possible.

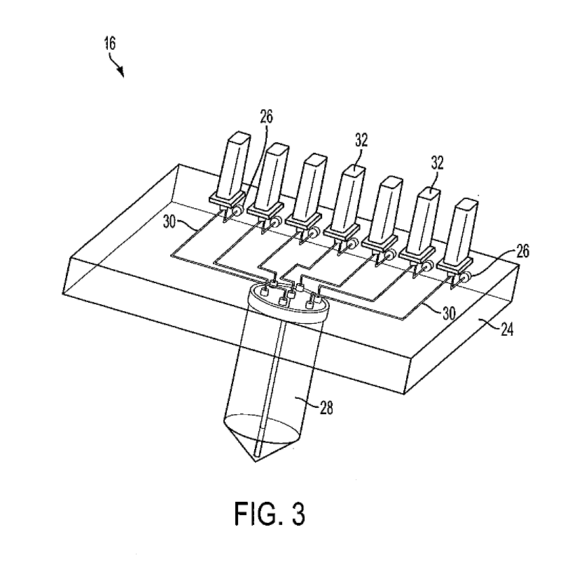

FIG. 3 shows a more detailed perspective view of the modular reaction block 16. The modular reaction block 16 may comprise a block or substrate 24. In other embodiments, a block 24 may not be used. The block 24 may be comprised of a substantially rigid or flexible material. Such materials may comprise a polymer, metal, wood, etc. Preferably, the block 24 is a chemically inert and radioactively resistant block of polymer. The block 24 may comprise at least two inlets/outlets 26 (one which can act as an inlet while the other acts as an outlet). Preferably, the block comprises a plurality of inlets/outlets 26. The inlets/outlets 26 (as inlets) may be in fluid communication with the modular reagent source 12 and/or the modular trap and release apparatus 14. In other embodiments, the inlets 26 of the modular reaction block 16 are in communication with a stationary, non-modular reagent source (e.g., a container that is the main reservoir feeding the synthesis system elements).

As shown in FIG. 3, the inlets 26 are in fluid communication with a reaction chamber 28, preferably, via at least one channel 30 and at least one valve 32. Preferably, the block 24 comprises a network of channels 30. The channels 30 may be configured to facilitate the passage of milliliters of material and may be about 10 micrometers to about 200 micrometers wide, or larger so as to accommodate up to 10 milliliters of liquid. Preferably, the channels 30 are within the block 24. The valves 32 may be two-way or three-way valves. They may also be “double valves” as shown in U.S. Ser. No. 11/540,344, which is incorporated by reference herein. The valves 32 regulate flow to and from the reaction vessel 28. Reagents and released radionuclide are dispended into the reaction vessel 28 as the center of synthesis of the compound.

The reaction vessel 28 may be almost any size and/or shape. For example, the reaction vessel 28 may be “coin-shaped” as shown in U.S. Ser. No. 11/540,344. In one embodiment, the reaction vessel 28 is configured to facilitate the reaction of a microfluidic amount of reagent. In another embodiment, it may have a hold volume in the milliliter amounts; for example, 1 mL to about 20 mL. Preferably, the reaction chamber 28 has a hold volume of about 1 mL to about 10 mL. In other embodiments, the reaction chamber 28 may have a smaller hold volume; for example, of about 1 microliter to about 100 microliters It may also be elongated; for example, a vial as shown in FIG. 3. It may be rounded, square, rectangular, oval, etc. It may be batch or flow-through but is preferably a batch reactor. The modular reaction block 16 may also comprise at least one vent (not shown) in communication with the reaction chamber 28. For example, one of the valves 32 and corresponding inlet/outlet 26 can act as a vent. In addition, a vacuum (not shown) may be configured to be in communication with the vent. The reaction block 16 may also comprise a gas permeable membrane (not shown) adjacent the reaction vessel 28. For example, the gas permeable membrane may be located inside the reaction vessel 28, right before the channels 30. The modular reaction block 16 also comprises at least one inlet/outlet 26 (as an outlet) which is in fluid communication with the reaction chamber. This outlet 26 facilitates the transportation of products of the reactions that take place within the reaction chamber 28. The reaction vessel block 16 may be docked to a tubing and electrical station (not shown) where other components may be, in turn be connected as part of the entire production line.

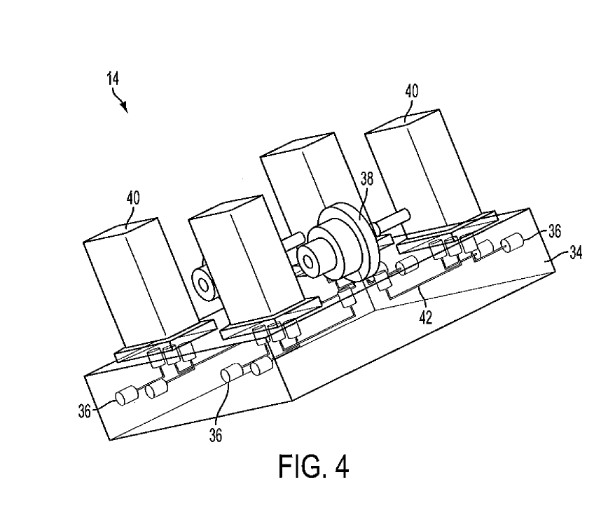

FIG. 4 shows a more detailed perspective view of the modular trap and release apparatus 14. Normally, two types of trap and release functions are used along the production, both of which are similar from the hardware standpoint and different from chemistry stand point. The modular trap and release apparatus 14 may comprise a block or substrate 34. In other embodiments, a block 34 may not be used. The block or substrate 34 may be made of the same material as the block 24 of the modular reaction block 16. Preferably, the block 34 is a chemically inert and radioactively resistant block of polymer. Preferably, the block 34 comprises a plurality of inlets/outlets 36. The inlets/outlets 36 (as inlets) may be in fluid communication with any component of the system or kit 10. Preferably, each inlet 36 is in communication with an outlet 54 of the modular reagent source 12. The inlets 36 may also be in fluid communication with an outlet of the purification system 20. The inlets/outlets 36 (as outlets) may be in fluid communication with the modular reaction block 16 and/or the modular intermediate collection apparatus 18.

The inlets/outlets 36 may be in fluid communication with a separation apparatus 38, configured to separate components of the reagent, via channels 42, which are preferably within the block. In one embodiment, the channels 42 are sized to transport milliliters of reagent. In particular, the channels 42 may be up to about 200 micrometers wide and larger (e.g., 1000 micrometers wide).

The modular trap and release apparatus 14 comprises at least one separation apparatus 38 configured to trap and release chemicals, atoms, etc. In this way, the separation apparatus 38 is configured to separate components of a reagent. Such an apparatus 38 may be a Solid Phase Extraction (SPE) cartridge with a two-stage flow of liquid through the SPE for trapping and releasing. The building block considered for this process may consist of multi-line, single use SPE sub-modules. The embodiment shown in FIG. 4 has two apparatuses 38 for nuclide trap and release and reformulation of the purified compound. The number of apparatuses 38 can be increased such that more than two apparatuses 38 are provided in the modular trap and release apparatus 14. Where an SPE is used as the apparatus 38, 3-way valves 40 per SPE may be mounted on the polymer block. SPE cartridges may be mounted on the upper surface of the solid block 34 using luer lock fittings or other suitable connectors.

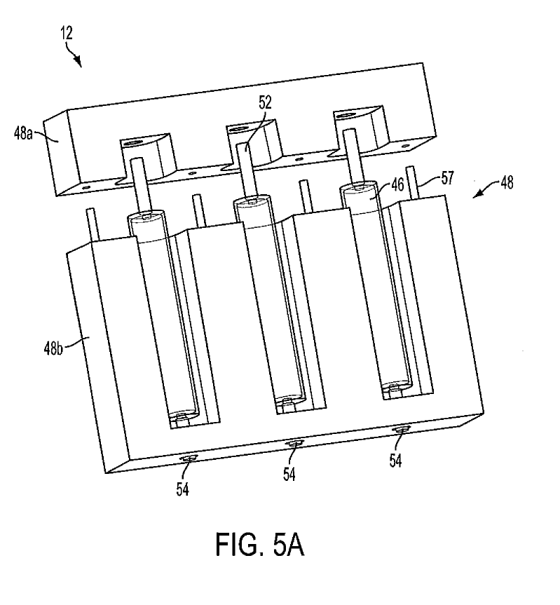

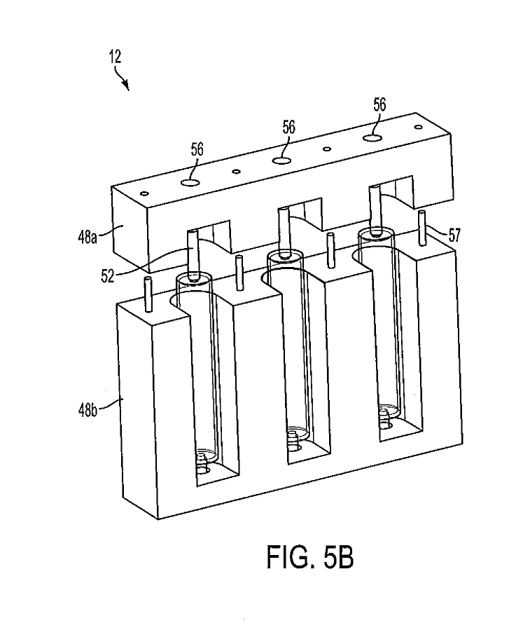

FIGS. 5A and 5B show a more detailed perspective view of the modular reagent source 12. The modular reagent source 12 comprises at least one container 46 for storing reagent. As shown in FIGS. 5A and 5B, preferably, the modular reagent source comprises a plurality of containers 46 storing different reagents. The containers 46 may be comprised of almost any suitable materials including glass, polymers such as plastic, metal, etc. The containers 46 may each be configured to hold milliliters of material; for example, 1 mL to about 1000 mL; preferably about 10 mL. In other embodiments, each container 46 may hold/transport 1 microliter to about 100 microliters or 1 microliter to 10 microliters. These reagents may include reagents for synthesizing a chemical; in particular a radioactive isotope of an atom such as ¹⁸F, ¹¹C, ¹³N, ¹⁵O, ⁶¹Cu, ⁶²Cu, ⁶⁴Cu, ⁶⁷Cu, ⁶⁸Ga, ¹²⁴I, ¹²⁵I, ¹³¹I, ⁹⁹Tc, ⁷⁵Br, ¹⁵³Gd, and ³²P. In one embodiment, the system is used to synthesize the [F-18]-labeled molecular probe, 2-deoxy-2-[F-18]-fluoro-D-glucose (FDG). Such reagents may include mannose triflate, HCl, H₂O, MeCN, K222, K₂CO₃, ¹⁸F or other radioactive isotope in H₂O, etc. It will be understood that different reagents may be needed to synthesize other radioactive or non-radioactive elements or molecules. In fact, one advantage of the present invention is that it allows any reagents to be easily changed and/or substituted in the reagent module 12, allowing easy synthesis of different chemicals or elements.

As shown in FIGS. 5A and 5B, the modular reagent source may comprise a block 48. The block may be comprised of a substantially rigid or flexible material. Such materials may comprise a polymer, metal, wood, etc. Preferably, the block 48 is a chemically inert and radioactively resistant block of polymer. The block 48 may be one piece or multiple pieces. In the embodiment shown in FIGS. 5A and 5B, the block 48 is comprised of an upper magazine 48a detachably connected to a lower magazine 48b via guiding pins 57. The lower magazine 48b houses the reagent vials 46 and the upper magazine 48a houses pressure activated check-valves 52 attached to the reagent vials 46. The vials 46 may be assembled inside the two-part vial magazine 48, which will be later closed and secured. Pressure activated check-valves 52 at both end of each vial allow for a complete seal and secured filling of the vials.

The reagent vials 46 also comprise at least one outlet 54, which may be in fluid communication with the modular trapping and release block 14, and/or the modular reaction vessel 16 or other components of the kit or system 10. The modular reagent block 12 may also comprise at least one inlet 56 (FIG. 5B) and at least one outlet 54 (FIG. 5A). The inlets 56 and outlets 54 may be configured to pass milliliters of reagent. The outlets 54 may be in fluid communication with the modular trap and release block 14 and/or the modular reaction block 16. The inlet 56 may be in communication with the pressure activated check valves 52 and/or the reagent source (not shown). The inlets 56 may receive gas such as N₂. The reagent source inlets 56 may also be in communication with water output from a cyclotron.

The modular reagent source or vial magazine 12 may be attached to the stationary pluming dock station (not shown) leading to the reaction chamber module 16 and/or the trap/release module 14.

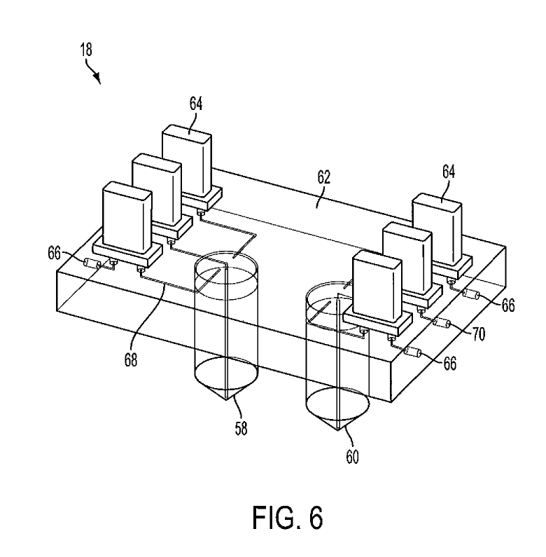

FIG. 6 shows a more detailed perspective view of the modular intermediate collection apparatus 18. The modular intermediate collection apparatus 18 may collect and store crude product subsequent to the completion of reaction and before purification in an intermediate vial. The intermediate collection apparatus 18 is preferably a vial for collection of the crude product or final product and may be placed anywhere along the entire production line. In general, modular intermediate collection apparatus 18 provides a temporary holding area for the reagent on the reagent's path through the system 10.

The modular intermediate collection apparatus 18 comprises at least one and preferably two collection vials 58, 60. Such vials 58, 60 may be virtually any shape as long as they can store an adequate amount of reagent and/or product. In one embodiment, the vials 58, 60 are configured to store milliliters of reagent. As such, they have a hold volume of about 1 mL to about 1000 mL; preferably about 10 mL. In other embodiments, they may hold 1 microliter to about 100 microliters; preferably 1 microliter to 10 microliters. The modular intermediate collection apparatus 18 may comprise a block 62. The block 62 may be comprised of a substantially rigid or flexible material. Such materials may comprise a polymer, metal, wood, etc. Preferably, the block 62 is comprised of the same material as the block of the reaction block and the trap and release block.

Each vial 58, 60 is in fluid communication with a set of inlets 66 and at least one outlet 70 via a set of channels 68 and a set of valves 64. Preferably, the channels 68 are within the block 62. In one embodiment, the inlets 66, outlets 70, and channels 68 are configured to facilitate the passage of milliliters of reagent. In particular, the channels 68 may be about 200 micrometers wide or larger and about 40 to 50 micrometers tall and larger. The valves 64 may be 2-way or 3-way valves. They may also be double valves. In one embodiment, at least one of the inlets 66 receives a gas such as N₂. Another inlet 66 may receive product from an outlet 26 of the modular reaction block 16 and/or the trap and release block 14. At least one outlet 70 may dispense product to a purification system 20 and/or to a final product holding storage/vial 22 (e.g., a vial, a vial module, a general storage chamber, etc.).

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. A variety of modifications to the embodiments described will be apparent to those skilled in the art from the disclosure provided herein. Thus, the present invention may be embodied in other specific forms without departing from the spirit or essential attributes thereof. Various changes may be made without departing from the spirit and scope of the inventions as defined in the following claims.

We claim:

1. A kit for synthesizing a compound or element, the kit comprising:
a modular reagent source comprising a reagent;
a modular trap and release apparatus configured to separate components of the reagent; and
a modular reaction unit which is in fluid communication with the modular reagent source and the modular trap and release apparatus;
wherein the modular reaction unit comprises a reaction vessel configured to facilitate a chemical reaction.

2. The kit of claim 1, further comprising:
a modular intermediate collection apparatus which is in fluid communication with the modular reaction unit;
wherein the modular intermediate collection apparatus comprises an intermediate collection vial.

3. The kit of claim 1, further comprising:
a purification apparatus which is in fluid communication with modular reaction unit, and is configured to purify a product of the reaction vessel.

4. The kit of claim 2, further comprising:
a product collection container in fluid communication with the modular reaction unit.

5. The kit of claim 4;
wherein the modular reagent source is in fluid communication with the modular trap and release apparatus;
wherein the modular the trap and release apparatus is in fluid communication with the modular reaction unit;
wherein the modular reaction unit is in fluid communication with the modular intermediate collection apparatus; and
wherein the modular intermediate collection apparatus is in fluid communication with the product collection vial.

6. The kit of claim 1;
wherein the modular reagent source comprises at least one inlet in communication with a gas source and the reagent.

7. The kit of claim 6;
wherein the modular reagent source comprises a pressure activated check valve and a plurality of reagent containers, each reagent container being in communication with the gas source.

8. The kit of claim 6;
wherein the gas source is N₂.

9. The kit of claim 6;
wherein the modular reagent source comprises at least an upper magazine detachably connected to a lower magazine.

10. The kit of claim 1;
wherein the modular trap and release apparatus comprises:
at least one inlet;
at least one outlet; and
a separation apparatus configured to separate components of the reagent;
wherein each inlet and outlet is in fluid communication with at least one valve; and
wherein the at least one valve is in fluid communication with the separation apparatus.

11. The kit of claim 10;
wherein the separation apparatus is a Solid Phase Extraction (SPE) cartridge.

12. The kit of claim 11;
wherein the modular trap and release apparatus comprises two SPE cartridges.

13. The kit of claim 10;
wherein the separation apparatus is an ion-exchange column.

14. The kit of claim 1;
wherein the modular trap and release apparatus comprises:
a block comprising the at least one inlet and at least one outlet; and
a separation apparatus configured to separate components of the reagent;
wherein the separation apparatus is attached to the block.

15. The kit of claim 1;
wherein the modular reaction unit comprises at least one inlet and at least one outlet, each of which is in fluid communication with the reaction chamber.

16. The kit of claim 15;
wherein the at least one inlet is in communication with the reaction chamber via at least one channel.

17. The kit of claim 16;
wherein the modular reaction unit comprises a block; and
wherein the block comprises the at least one channel, the at least one inlet; and the at least one outlet.

18. The kit of claim 2;
wherein the modular intermediate collection apparatus comprises a plurality of inlets and at least one outlet, the inlets and the at least one outlet being in fluid communication with the intermediate collection vial;
wherein at least one first inlet of the plurality of inlets is in communication with a gas source; and
wherein at least one second inlet of the plurality of inlets is in communication with the modular reaction unit.

19. The kit of claim 18;
comprising at least two intermediate collection vials.

20. The kit of claim 18, further comprising:
at least one valve in fluid communication with the intermediate collection vial, the inlets, and the at least one outlet.

21. The kit of claim 18;
wherein the modular intermediate collection apparatus comprises:
a block comprising the inlets and at least one outlet.

22. The kit of claim 1;
wherein the modular reagent source, modular trap and release apparatus, and modular reaction unit are microfluidic-sized, so as to each be configured to hold a maximum fluidic volume in the range of 1 μL to 10 mL.

23. The kit of claim 1;
wherein the modular reagent source, modular trap and release apparatus, and modular reaction unit are in fluid communication with each other via a docking station.

24. The kit of claim 23;
wherein the docking station comprises channels configured to provide the fluid communication, and to provide electrical circuitry.

25. An apparatus for synthesizing a compound or element, the apparatus comprising:
a modular reagent source unit configured to contain a reagent;
a modular trap and release unit configured to separate components of the reagent; and
a modular reaction unit which is in fluid communication with the modular reagent source unit and the modular trap and release unit;
wherein the modular reaction unit comprises a reaction vessel configured to facilitate a chemical reaction.

26. The apparatus of claim 25, further comprising:
a modular intermediate collection unit which is in fluid communication with the modular reaction unit;
wherein the modular intermediate collection unit comprises an intermediate collection vial.

27. The apparatus of claim 25, further comprising:
a purification unit which is in fluid communication with modular reaction unit, and is configured to purify a product of the reaction vessel.

28. The apparatus of claim 26, further comprising:
a product collection unit in fluid communication with the modular reaction unit.

29. The kit of claim 26;
wherein the modular reagent source unit is in fluid communication with the modular trap and release unit;
wherein the modular the trap and release unit is in fluid communication with the modular reaction unit;
wherein the modular reaction unit is in fluid communication with the modular intermediate collection unit; and
wherein the modular intermediate collection unit is in fluid communication with the product collection vial.
